(19) United States
(12) Patent Application Publication
(10) Pub. No.: US 2019/0188657 A1
(43) Pub. Date: Jun. 20, 2019

(54) METHOD AND SYSTEM FOR OUTSIDE GUARANTEES FOR A BLOCKCHAIN TRANSACTION

(71) Applicant: Mastercard International Incorporated, Purchase, NY (US)

(72) Inventors: Ankur ARORA, Jasola (IN); Avinash KUMAR, Bokaro (IN); Avdhesh VYAS, Gurgaon (IN); Srishti GUPTA, Dadabari (IN)

(73) Assignee: Mastercard International Incorporated, Purchase, NY (US)

(21) Appl. No.: 15/846,451

(22) Filed: Dec. 19, 2017

(51) Int. Cl. G06Q 20/06; G06Q 20/36; G06F 17/30

(52) U.S. Cl. CPC G06Q 20/0658; H04L 9/3247; G06F 17/30283; G06Q 20/36

(57) ABSTRACT

A method for guaranteeing a blockchain transaction includes: storing account profiles, each related to a transaction account including a current balance and identification data; receiving a blockchain transaction request including a sending identifier, receiving identifier, and blockchain currency amount; transferring an alternative currency amount based on the blockchain currency amount from a first account profile including the sending identifier to a second account profile including the receiving and sending identifiers; restricting access to the current balance in the second account profile from the first account; receiving a confirmation of a blockchain transaction within a predetermined period of time; and transferring, from the second account profile, the alternative currency amount to the first account profile if the confirmation is received within the predetermined period of time, or to a third account profile including the receiving identifier if the confirmation is not received within the predetermined period of time.

### FIELD

The present disclosure relates to the guaranteeing of a blockchain transaction via an alternative payment network, specifically the use of separate accounts with shared access that utilize an alternative currency to serve as a guarantee for a blockchain transaction due to the long processing times associated with blockchain transactions to provide for the ability to make real-time decisions for a blockchain transaction.

### BACKGROUND

Blockchains, when used for transactions for the exchange of currency, such as cryptographic currencies or other currencies that may be exchange via blockchain, can provide a number of benefits. As blockchain transactions are conducted between electronic wallets, blockchains afford a level of anonymity and security to users. In addition, the immutable nature of the blockchain itself can prevent fraud and provide additional security to its users as, short of physical control of the wallet, currency can generally not be stolen or intercepted in any way. Thus, blockchains can be beneficial to consumers for a variety of reasons, which may be helpful in Internet-based transactions as well as in-person transactions where the consumer may want to use a blockchain for payment, such as for the added security of their funds, anonymity of their true identity, and inability for their purchase to be tracked or attributed.

However, the processing of blockchain transactions relies on complicated mathematics to be performed in addition to the various verification processes to ensure that the sending wallet has sufficient funds to cover a transaction and is authorized to access those funds, which takes, on average, ten minutes. For many transactions, this kind of delay time may be unacceptable. For instance, a person visiting a physical merchant that may want to use blockchain for funding the transaction at a point of sale may unduly hinder a merchant's operation by taking up a register for ten minutes as they await the outcome of the blockchain process to ensure the fund transfer was successful.

As such, there is a need for a technical solution to provide for a guarantee to an intended recipient in a blockchain transaction that their interests will be covered immediately, in real time, when the transaction is submitted, enabling the recipient to make an immediate decision as to the outcome of the blockchain transaction without having to wait for the lengthy processing time.

### SUMMARY

The present disclosure provides a description of systems and methods for guaranteeing a blockchain transaction via an alternative payment network. The systems and methods discussed herein utilize a separate payment network that use a different currency in alternative to a blockchain currency to guarantee transactions conducted using the blockchain. When a blockchain transaction is proposed, the sender automatically and immediately transfers an equivalent amount in the alternative currency to a special account that is assigned to both the sender and recipient, where control of the funds in the account is based on the outcome of the blockchain transaction. This serves as a guarantee for the blockchain transaction where the intended recipient may withdraw the alternative currency if the blockchain transaction fails, or where the sender may be returned the alternative currency if the blockchain transaction succeeds, enabling the recipient to make a real-time decision to honor the intended transaction, knowing that their interest is covered, despite the long processing time of the blockchain transaction. The use of the alternative currency and shared account provides for stronger security and less opportunity for fraud, and enables real-time guaranteeing that cannot be provided via the use of escrow services dealing with the blockchain transaction itself.

A method for guaranteeing a blockchain transaction via an alternative payment network includes: storing, in an account database of a processing server, a plurality of account profiles, wherein each account profile is a structured data set related to a transaction account including at least a current balance and identification data for one or more associated blockchain accounts; receiving, by a receiving device of the processing server, a blockchain transaction request, wherein the transaction request includes at least a sending blockchain identifier, a receiving blockchain identifier, and a blockchain currency amount; executing, by a querying module of the processing server, a first query on the account database to transfer, from a first account profile where the identification data includes the sending blockchain identifier, an alternative currency amount based on the blockchain currency amount to a second account profile, where the second account profile includes the sending blockchain identifier and the receiving blockchain identifier; restricting, by the processing server, access to the current balance included in the second account profile from the transaction account associated related to the first account profile; receiving, by the receiving device of the processing server, a confirmation of a blockchain transaction within a predetermined period of time, wherein the blockchain transaction includes transfer of the blockchain currency amount from a first blockchain wallet associated with the sending blockchain identifier to a second blockchain wallet associated with the receiving blockchain identifier; and executing, by the querying module of the processing server, a second query on the account database to transfer, from the second account profile, the alternative currency amount to the first account profile following receipt of the confirmation of the blockchain transaction if the confirmation is received within the predetermined period of time; or executing, by the querying module of the processing server, a third query on the account database to transfer, from the second account profile, the alternative currency amount to a third account profile where the identification data includes the receiving blockchain identifier if the confirmation is not received within the predetermined period of time.

A system for guaranteeing a blockchain transaction via an alternative payment network includes: an account database of a processing server configured to store a plurality of account profiles, wherein each account profile is a structured data set related to a transaction account including at least a current balance and identification data for one or more associated blockchain accounts; a receiving device of the processing server configured to receive a blockchain transaction request, wherein the transaction request includes at least a sending blockchain identifier, a receiving blockchain identifier, and a blockchain currency amount; and a querying module of the processing server configured to execute a first query on the account database to transfer, from a first account profile where the identification data includes the sending blockchain identifier, an alternative currency amount based on the blockchain currency amount to a second account profile, where the second account profile includes the sending blockchain identifier and the receiving blockchain identifier, wherein the processing server is configured to restrict access to the current balance included in the second account profile from the transaction account associated related to the first account profile, the receiving device of the processing server is further configured to receive a confirmation of a blockchain transaction within a predetermined period of time, wherein the blockchain transaction includes transfer of the blockchain currency amount from a first blockchain wallet associated with the sending blockchain identifier to a second blockchain wallet associated with the receiving blockchain identifier, and the querying module of the processing server is further configured to execute a second query on the account database to transfer, from the second account profile, the alternative currency amount to the first account profile following receipt of the confirmation of the blockchain transaction if the confirmation is received within the predetermined period of time, or execute a third query on the account database to transfer, from the second account profile, the alternative currency amount to a third account profile where the identification data includes the receiving blockchain identifier if the confirmation is not received within the predetermined period of time.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for guaranteeing a blockchain transaction using alternative currency in accordance with exemplary embodiments.

FIG. 2 is a block diagram illustrating the processing server of the system of FIG. 1 for guaranteeing a blockchain transaction via an alternative currency in accordance with exemplary embodiments.

FIG. 3 is a flow diagram illustrating a process for the guaranteeing of a blockchain transaction via an alternative currency using the system of FIG. 1 in accordance with exemplary embodiments.

FIG. 4 is a flow chart illustrating an exemplary method for guaranteeing a blockchain transaction via an alternative payment network in accordance with exemplary embodiments.

FIG. 5 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes for thousands, millions, and even billions of transactions during a given period. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

Blockchain—A public ledger of all transactions of a blockchain-based currency. One or more computing devices may comprise a blockchain network, which may be configured to process and record transactions as part of a block in the blockchain. Once a block is completed, the block is added to the blockchain and the transaction record thereby updated. In many instances, the blockchain may be a ledger of transactions in chronological order, or may be presented in any other order that may be suitable for use by the blockchain network. In some configurations, transactions recorded in the blockchain may include a destination address and a currency amount, such that the blockchain records how much currency is attributable to a specific address. In some instances, the transactions are financial and others not financial, or might include additional or different information, such as a source address, timestamp, etc. In some embodiments, a blockchain may also or alternatively include nearly any type of data as a form of transaction that is or needs to be placed in a distributed database that maintains a continuously growing list of data records hardened against tampering and revision, even by its operators, and may be confirmed and validated by the blockchain network through proof of work and/or any other suitable verification techniques associated therewith. In some cases, data regarding a given transaction may further include additional data that is not directly part of the transaction appended to transaction data. In some instances, the inclusion of such data in a blockchain may constitute a transaction. In such instances, a blockchain may not be directly associated with a specific digital, virtual, fiat, or other type of currency.

### System for Guaranteeing a Blockchain Transaction

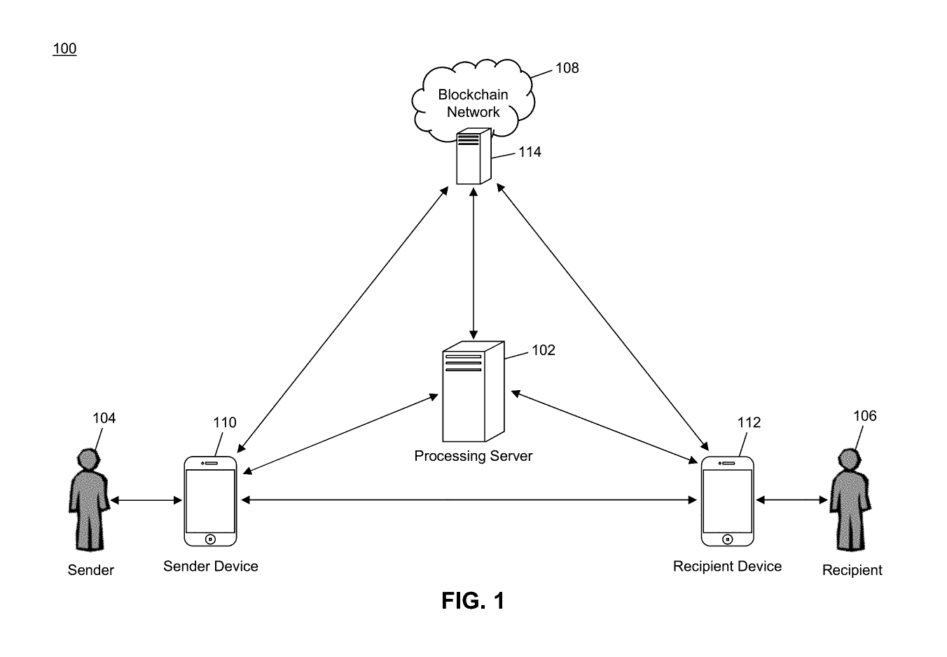

FIG. 1 illustrates a system 100 for guaranteeing a blockchain transaction via the use of an alternative payment network that utilizes an alternative currency where shared access to an account in the alternative currency can provide an intended recipient of the blockchain transaction the ability to make a real-time decision without waiting for long processing times of blockchain transactions.

The system 100 may include a processing server 102. The processing server 102, discussed in more detail below, may be configured to provide a guarantee to both a sender 104 and recipient 106 that are participating in a blockchain transaction, where the guarantee is provided via a shared-access account using an alternative currency in an alternative payment network, which may be operated by the processing server 102 or other system with which the processing server 102 may be associated.

In the system 100, the sender 104 may initiate a blockchain transaction for payment of a specified amount of blockchain currency to the recipient 106. The blockchain transaction may be a transaction that is to be conducted via the use of a blockchain associated with a blockchain network 108. The blockchain network 108 may be comprised of a plurality of nodes 114, where each node is configured to verify proposed blockchain transactions, generate new blocks for the blockchain, validate new blocks, and maintain a copy of the blockchain. The blockchain itself may be comprised of a plurality of blocks, where each block includes at least a block header and one or more transaction data values.

A block header may include at least a timestamp, a block reference value, and a transaction reference value. The timestamp may be a time at which the block header is generated, or may refer to a time by which each of the transaction data values in the respective block may be submitted. The block reference value may be a reference to an earlier block in the blockchain, such as a reference to the block header of the most recent block (e.g., based on timestamp) added to the blockchain prior to the respective block. In some embodiments, the block reference value may be a hash value generated via hashing of the block header of the preceding block. The transaction reference value may be a reference to the transaction data values included in the respective block. In some embodiments, the transaction reference value may be the root of a Merkle tree that is generated using the transaction data values. The use of the reference values may ensure immutability of the blockchain, as any modification to a transaction data value or block header necessitates changing of the corresponding transaction reference value and the block reference value included in every subsequent block in the blockchain, which must be performed in a majority of nodes 114 in the blockchain network 108, and prior to any new blocks being added, which may be computationally and communicatively impossible.

The transaction data values may each correspond to a blockchain transaction. A blockchain transaction may be conducted between two blockchain wallets, such as may be associated with a sender 104 and a recipient 106. Traditionally, a blockchain wallet refers to a private key of a cryptographic key pair that is used to digitally sign transactions that are funded via that blockchain wallet. As discussed herein, “blockchain wallet” or “electronic wallet” may refer to the private key itself, the device that stores the private key, or the user in possession and/or control of the private key, as applicable. A transaction data value may include at least one sending address, a digital signature associated with the sending address(es), a recipient address, and a blockchain amount. Each of the sending addresses may be associated with the blockchain wallet that funds the respective transaction. A sending address may be generated via the public key of the cryptographic key pair that includes the blockchain wallet's private key. In some cases, multiple sending addresses may be included in a transaction data value, such as to accommodate for transactions where the amount being transferred is greater than the amount associated with any individual sending address attributed to the sending blockchain wallet. The digital signature may be generated via the private key of the sending blockchain wallet and may be used (e.g., by nodes 114) to verify that the wallet is the authorized owner of the currency attributable to the sending addresses. The recipient address may be an address generated by the public key of the intended recipient's blockchain wallet, and may be where the currency is to be transferred as part of the blockchain transaction. The blockchain amount may be the amount of blockchain currency to be transferred as part of the blockchain transaction.

In the system 100, a traditional blockchain transaction would entail the sender 104 submitting a transaction request to a node 114 in the blockchain network 108 via a sender device 110. The sender device 110 may be a computing device that serves as a blockchain wallet for the blockchain, where the sender device 110 stores the private key associated with the sender's blockchain wallet. The transaction request would include any addresses controlled by the blockchain wallet that have sufficient currency to cover an included blockchain amount, as well as one or more digital signatures generated by the sender device 110 using the private key, and a recipient address generated by the public key of the recipient 106, which may be generated by a recipient device 112 of the recipient or by the sender device 110 using a public key provided by the recipient device 112. The sender device 110 and recipient device 112 may be any suitable type of computing device that is configured to perform the functions discussed herein, such as a desktop computer, laptop computer, notebook computer, tablet computer, cellular phone, smart phone, smart watch, smart television, wearable computing device, implantable computing device, integrated circuit card, etc.

In a traditional blockchain transaction, the node 114 would validate the digital signature and the sending addresses to ensure that the sender 104 has sufficient blockchain currency to cover the blockchain amount, and include the transaction in a new block that is generated, validated by other nodes 114, and then added to the blockchain in a process that takes roughly ten minutes. The recipient 106 would then have access to the blockchain currency via the recipient address, which they could use as the sending address in a future transaction. In some cases, a transaction may have multiple sending addresses, such as where the sender 104 is sending an amount to multiple recipients 106, or where the sender 104 is receiving change from the transaction (e.g., the sending address may be associated with 50 units of currency, where the recipient 106 is only to receive 30, so the remaining 20 may be returned to an address associated with the sender's blockchain wallet).

In the system 100, the processing server 102 may be configured to provide for a guarantee as to a proposed blockchain transaction, which may enable the recipient 106 to make an immediate decision, in real-time, whether or not to honor the blockchain transaction without having to wait for the ten minute processing period. In the system 100, the sender 104 may, via the sender device 110, submit a proposed blockchain transaction. In some cases, the proposed blockchain transaction may be submitted to a node 114, which may then forward the transaction request to the processing server 102. In other cases, the sender 104 may, via the sender device 110, send the transaction request directly to the processing server 102. The transaction request may include at least the sending and receiving addresses and the blockchain currency amount. In some cases, the transaction request may also include the digital signature generated by the sender device 110 and/or may include information identifying the sender 104 or an alternative currency account associated with the sender 104, discussed in more detail below, such as an account identifier, identification number, username, e-mail address, telephone number, device identifier associated with the sender device 110, etc.

The processing server 102 may store an account profile for a plurality of transaction accounts that utilize an alternative currency. The alternative currency may be a fiat currency, a virtual currency, a cryptographic currency, any other type of currency that is distinct from the blockchain currency used in the blockchain network 108. The processing server 102 may receive the transaction request and identify an account profile associated with the sender 104, which may be identified via identification data included in the transaction request or the sender address. For instance, the account profile may include the public key associated with the sender's blockchain wallet, where the account profile may be identified via the sending address as being generated via the included public key.

Once the transaction account is identified, the processing server 102 may immediately initiate a transfer of alternative currency from the transaction account to a second transaction account. In some instances, the amount of alternative currency may be based on the blockchain currency amount being transferred, such as being an equivalent value (e.g., based on an exchange rate). In other instances, the amount of alternative currency may not be based on the blockchain currency amount, such as it may be a predetermined value that is sufficient to serve as a guarantee for the blockchain transaction. The alternative currency may be transferred to a second transaction account, which may be a shared account to which the sender 104 and recipient 106 are both associated. Association with the shared account may entail that both the sender 104 and recipient 106 may view the balance of the account (e.g., to ensure that the proper amount of currency was transferred thereto from the sender 104). In some cases, both the sender 104 and recipient 106 may have access to the shared transaction account to perform various functions associated therewith, but where the ability to transfer money out of the account may be restricted depending on the outcome of the blockchain transaction. For instance, the processing server 102 may limit the ability for either party to withdraw the alternative currency until the blockchain transaction has been processed, and may then enable one of the two parties to withdraw currency depending on the processing of the blockchain transaction.

The processing server 102 may wait a predetermined period of time to await the outcome of the blockchain transaction. The predetermined period of time may be set by the sender 104, recipient 106, processing server 102, or blockchain network 108. For instance, in one example, it may be based on the average processing time of blockchain transactions. In embodiments where the transaction request may be forwarded to the processing server 102 by a node 114 in the blockchain network 108, the processing server 102 may not need to perform any additional actions prior to receipt of a notification regarding the outcome of the blockchain transaction. In embodiments where the sender 104 submits the transaction request to the processing server 102 directly, the processing server 102 may submit the transaction request to a node 114 in the blockchain network 108 on behalf of the sender 104.

Once the blockchain transaction is processed, either successfully or unsuccessfully, the processing server 102 may be notified, either by a node 114 of the blockchain network 108, by the sender device 110 or recipient device 112 (e.g., which may include data identifying the blockchain transaction data entry that corresponds to the transaction), or detected by the processing server 102 via monitoring of new blocks added to the blockchain. In some embodiments, the processing server 102 itself may be a node 114, and may identify if processing of the blockchain transaction is successful or unsuccessful using standard blockchain processing methods, such as by including the transaction in a new block that is validated by other nodes 114 or by receiving and validating a block generated by another node 114 that includes the blockchain transaction.

If the blockchain transaction is unsuccessful, or if the predetermined period of time has passed without a successful confirmation of the blockchain transaction, then the processing server 102 may remove the restriction on withdrawal of the shared account by the recipient 106. The recipient 106 may then, via the recipient device 112, request withdrawal of the alternative currency to a transaction account associated with the recipient 106. The processing server 102 may perform the transfer such that the recipient 106 receives the alternative currency, such as to compensate for the inability of the sender 104 to perform the blockchain transaction as intended. If the blockchain transaction is successful, such as indicated to the processing server 102 by a confirmation of the blockchain transaction as a transaction data value in a new block in the blockchain, then the processing server 102 may return the alternative currency to the transaction account associated with the sender 104. In some cases, the predetermined period of time may be a time until the appropriate party requests withdrawal of the alternative currency. In some embodiments, the sender 104 and recipient 106 may each be removed as being associated with the shared transaction account, which may enable the shared transaction account to be used again to guarantee a future blockchain transaction.

In some embodiments, the transfer of alternative currency from the shared transaction account to the appropriate transaction account may be performed automatically by the processing server 102 once the confirmation of the blockchain transaction is received or the predetermined period of time expires. In other embodiments, the alternative currency may remain in the shared transaction account until a transfer is requested by the appropriate party. For instance, in one example, the sender 104 and recipient 106 may participate in a plurality of different blockchain transactions over a period of time. The sender 104 or recipient 106, as applicable, may elect to wait until all of the transactions have been processed to make a single withdrawal from the shared transaction account, where the balance of the shared transaction account may increase throughout the requesting of the various blockchain transactions. For instance, the sender 104 may make a number of micropayments to the recipient 106, where it may be more economical (e.g., due to fees, convenience, accounting, etc.) to make a single transfer following the blockchain transactions.

In a more detailed example, the sender 104 may intend to make a series of micropayments via the blockchain network 108 to the recipient 106 over the course of several days. When the first transaction request is submitted to the processing server 102, the processing server 102 may transfer an alternative currency amount from the sender's transaction account that covers a large number of micropayments. The sender 104 may then submit blockchain transactions to the blockchain network 108 for the micropayments over the course of the several days, where the processing server 102 may continually track the successful or unsuccessful processing of each micropayment transaction. Once the sender 104 is finished, the sender 104 may then request withdrawal of the alternative currency from the shared transaction account, where the processing server 102 may have maintained an alternative currency amount based on the success or failure of the micropayment blockchain transactions. For instance, the initial transfer may have been for 50 units of alternative currency, where each micropayment is for the equivalent of one unit of alternative currency. The sender 104 may have made 45 successful blockchain micropayments and five failed blockchain micropayments. In such an instance, the processing server may authorize a single withdrawal of 45 units of alternative currency by the sender 104, and may authorize (e.g., or automatically process) a withdrawal of five units of alternative currency by the recipient 106. In such an example, fifty different blockchain transactions may be guaranteed by only three transfers conducted by the processing server 102.

The methods and systems discussed herein may provide for a guarantee of a blockchain transaction using an alternative currency that may enable an intended recipient 106 of a blockchain transaction to make an immediate decision regarding the blockchain transaction in real time. For instance, the sender 104 may visit a physical merchant (e.g., as the recipient 106) and want to use a blockchain currency as a form of payment for goods or services. In a traditional blockchain transaction, the merchant would have to wait ten minutes before ensuring that they received payment, thus significantly delaying the transaction process, or forcing the merchant to trust that the sender 104 has the sufficient currency and will honor the payment. In the system 100, the transaction may be immediately and automatically guaranteed by the alternative currency transferred from the sender's transaction account, which may be immediately verifiable by the merchant in real time via the shared transaction account. The merchant may then be able to immediately approve the transaction, confident that they will either receive the blockchain currency as intended or receive a suitable amount of alternative currency to cover the blockchain currency if the blockchain transaction fails. In addition, the use of aggregation by the processing server 102 for groups of transactions or micropayments may provide for additional convenience to senders 104 and recipients 106 when making or taking advantage of guarantees for blockchain transactions.

### Processing Server

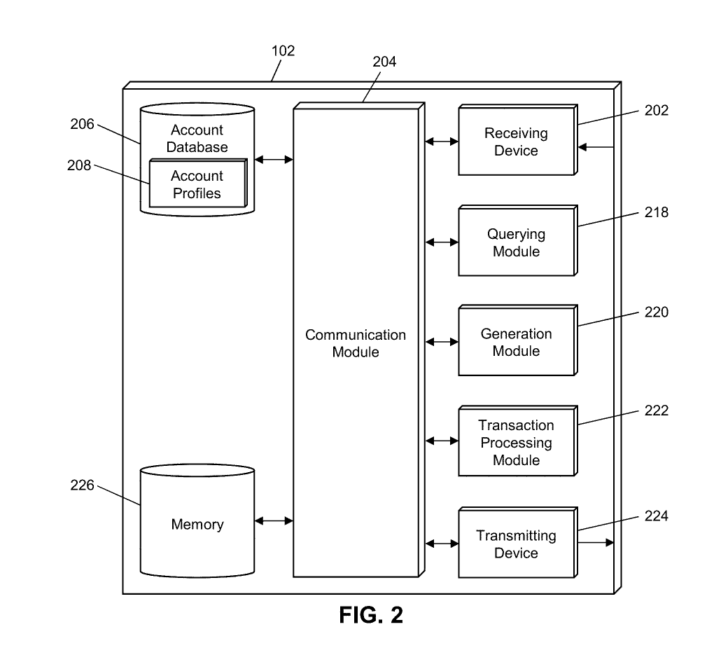

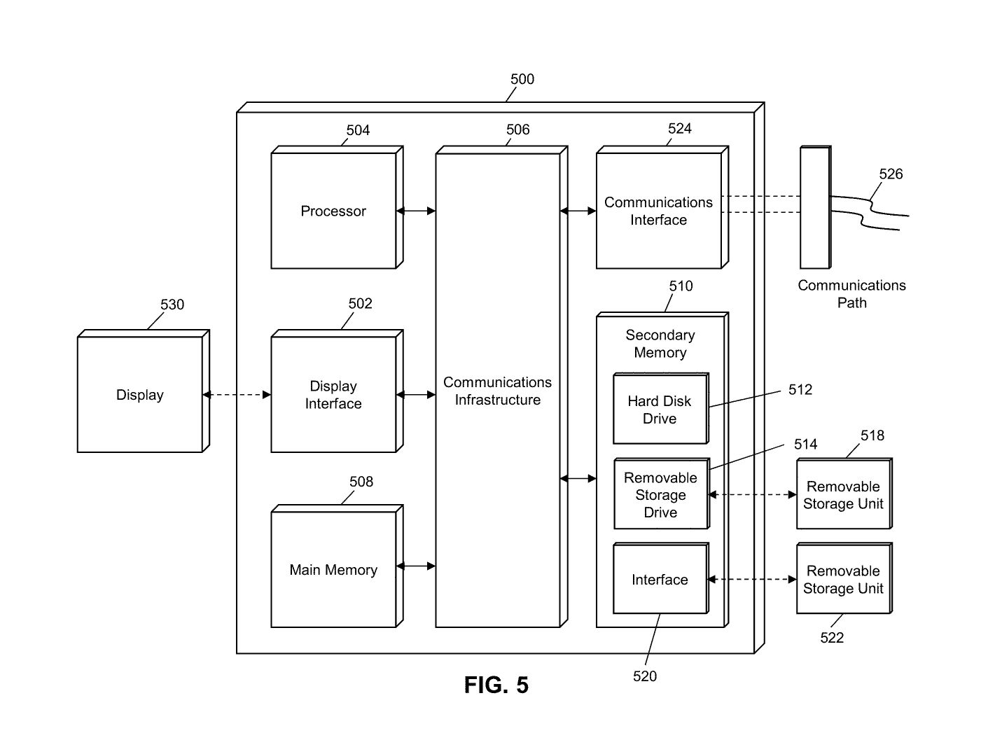

FIG. 2 illustrates an embodiment of a processing server 102 in the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 500 illustrated in FIG. 5 and discussed in more detail below may be a suitable configuration of the processing server 102.

The processing server 102 may include a receiving device 202. The receiving device 202 may be configured to receive data over one or more networks via one or more network protocols. In some instances, the receiving device 202 may be configured to receive data from sender devices 110, recipient devices 112, nodes 114, and other systems and entities via one or more communication methods, such as radio frequency, local area networks, wireless area networks, cellular communication networks, Bluetooth, the Internet, etc. In some embodiments, the receiving device 202 may be comprised of multiple devices, such as different receiving devices for receiving data over different networks, such as a first receiving device for receiving data over a local area network and a second receiving device for receiving data via the Internet. The receiving device 202 may receive electronically transmitted data signals, where data may be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by sender devices 110, recipient devices 112, or nodes 114 that may be superimposed or otherwise encoded with a transaction request, which may include at least a sending blockchain identifier (e.g., one or more sending addresses, a sender public key, etc.), a receiving blockchain identifier (e.g., a recipient address, recipient public key, etc.), and a blockchain currency amount. In some cases, the transaction request may also include an account identifier associated with a transaction account, an alternative currency amount for guaranteeing, a number of expected blockchain transactions, or other data that may be used in the performance of the functions discussed herein. The receiving device 202 may also be configured to receive data signals electronically transmitted by nodes 114 in the blockchain network 108 that may be superimposed or otherwise encoded with blockchain transaction confirmations or blockchain transaction data that may be used by the processing server 102 to confirm processing of a blockchain transaction. The receiving device 202 may be further configured to receive data signals electronically transmitted by sender devices 110 and recipient devices 112 that are superimposed or otherwise encoded with withdrawal requests for withdrawal of alternative currency from a shared transaction account. Such requests may include information identifying the submitter and/or the transaction account to which the alternative currency is to be transferred, may specify an amount of alternative currency, and/or may refer to one or more blockchain transactions or transaction requests to which the withdrawal pertains.

The processing server 102 may also include a communication module 204. The communication module 204 may be configured to transmit data between modules, engines, databases, memories, and other components of the processing server 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the processing server 102 and external components of the processing server 102, such as externally connected databases, display devices, input devices, etc. The processing server 102 may also include a processing device. The processing device may be configured to perform the functions of the processing server 102 discussed herein as will be apparent to persons having skill in the relevant art. In some embodiments, the processing device may include and/or be comprised of a plurality of engines and/or modules specially configured to perform one or more functions of the processing device, such as a querying module 218, generation module 220, transaction processing module 222, etc. As used herein, the term “module” may be software or hardware particularly programmed to receive an input, perform one or more processes using the input, and provides an output. The input, output, and processes performed by various modules will be apparent to one skilled in the art based upon the present disclosure.

In some embodiments, the processing server 102 may include an account database 206. The account database 206 may be configured to store a plurality of account profiles 208 using a suitable data storage format and schema. The account database 206 may be a relational database that utilizes structured query language for the storage, identification, modifying, updating, accessing, etc. of structured data sets stored therein. Each account profile 208 may be a structured data set configured to store data related to a transaction account including at least an account balance and identification data. In some cases, the identification data may be directly associated with a blockchain wallet, such as a public key, a series of addresses, or other suitable type of identification data. In other cases, the identification data may include any suitable value or values that may be included in a transaction request and in other communications received from the associated entity (e.g., the sender 104 or recipient 106). The account balance may be a balance of alternative currency that may be debited or credited based on transfers to or from shared transaction accounts, and may be withdrawn by the related user to an external account or converted into an additional type of currency, such as a fiat currency. Some account profiles 208 may be related to shared transaction accounts that may have multiple sets of identification data included therein (e.g., corresponding to each user that is associated with the shared transaction account), and may also have restrictions placed thereon controlling what entity may be able to withdraw alternative currency at any given time.

The processing server 102 may include a querying module 218. The querying module 218 may be configured to execute queries on databases to identify information. The querying module 218 may receive one or more data values or query strings, and may execute a query string based thereon on an indicated database, such as the account database 206, to identify information stored therein. The querying module 218 may then output the identified information to an appropriate engine or module of the processing server 102 as necessary. The querying module 218 may, for example, execute a query on the account database 206 to assign a sender 104 and recipient 106 for a proposed blockchain transaction to an account profile 208 associated with a shared transaction account, or to effect a transfer of alternative currency to/from a shared transaction account and a transaction account associated with one of the participants of one or more blockchain transactions. The querying module 218 may also be configured to execute queries on account profiles 208 to modify access to the alternative currency included therein.

The processing server 102 may also include a generation module 220. The generation module 220 may be configured to generate data for use by the processing server 102 in performing the functions discussed herein. The generation module 220 may receive instructions as input, may generate data based on the instructions, and may output the generated data to one or more modules of the processing server 102. For example, the generation module 220 may be configured to generate notifications and other data messages for transmission to nodes 114, sender devices 110, and recipient devices 112. For instance, the generation module 220 may generate a request for a blockchain transaction for submission to a node 114 based on a received transaction request. In embodiments where the processing server 102 may be a node 114 in the blockchain network 108, the generation module 220 may be configured to generate reference values, block headers, and new blocks as part of the traditional functions as a node 114 in a blockchain network 108.

The processing server 102 may also include a transaction processing module 222. The transaction processing module 222 may be configured to perform functions associated with the processing of transactions as part of the processing server 102 as discussed herein. For example, the transaction processing module 222 may be configured to perform transfers of alternative currency between transaction accounts, calculate fees or other values, determine exchange rates between currency types, convert alternative currency to/from blockchain currency and other currencies, etc.

The processing server 102 may also include a transmitting device 224. The transmitting device 224 may be configured to transmit data over one or more networks via one or more network protocols. In some instances, the transmitting device 224 may be configured to transmit data to sender devices 110, recipient devices 112, nodes 114, and other entities via one or more communication methods, local area networks, wireless area networks, cellular communication, Bluetooth, radio frequency, the Internet, etc. In some embodiments, the transmitting device 224 may be comprised of multiple devices, such as different transmitting devices for transmitting data over different networks, such as a first transmitting device for transmitting data over a local area network and a second transmitting device for transmitting data via the Internet. The transmitting device 224 may electronically transmit data signals that have data superimposed that may be parsed by a receiving computing device. In some instances, the transmitting device 224 may include one or more modules for superimposing, encoding, or otherwise formatting data into data signals suitable for transmission.

The transmitting device 224 may be configured to electronically transmit data signals to sender devices 110 and recipient devices 112 that are superimposed or otherwise encoded with notifications, such as may notify the appropriate entity of access restrictions placed on or removed from a shared transaction account, successful transfers of alternative currency to/from an associated transaction account, successful exchanges of alternative currency to other types of currency, receipt of a confirmation of a blockchain transaction, etc. The transmitting device 224 may also be configured to transmit data signals to nodes 114, which may be superimposed or otherwise encoded with a request for a blockchain transaction to be processed or a request for data regarding a processed blockchain transaction. In cases where the processing server 102 may be a node 114, the transmitting device 224 may be configured to transmit generated blocks to other nodes 114 for validation or to transmit validation results as performed by the processing server 102 to other nodes 114 in the blockchain network 108.

The processing server 102 may also include a memory 226. The memory 226 may be configured to store data for use by the processing server 102 in performing the functions discussed herein, such as public and private keys, symmetric keys, etc. The memory 226 may be configured to store data using suitable data formatting methods and schema and may be any suitable type of memory, such as read-only memory, random access memory, etc. The memory 226 may include, for example, encryption keys and algorithms, communication protocols and standards, data formatting standards and protocols, program code for modules and application programs of the processing device, and other data that may be suitable for use by the processing server 102 in the performance of the functions disclosed herein as will be apparent to persons having skill in the relevant art. In some embodiments, the memory 226 may be comprised of or may otherwise include a relational database that utilizes structured query language for the storage, identification, modifying, updating, accessing, etc. of structured data sets stored therein. The memory 226 may be configured to store, for example, exchange rates, access restriction rules, address generation rules and algorithms, hashing algorithms for generating reference values, algorithms for

### Process for Guaranteeing a Blockchain Transaction

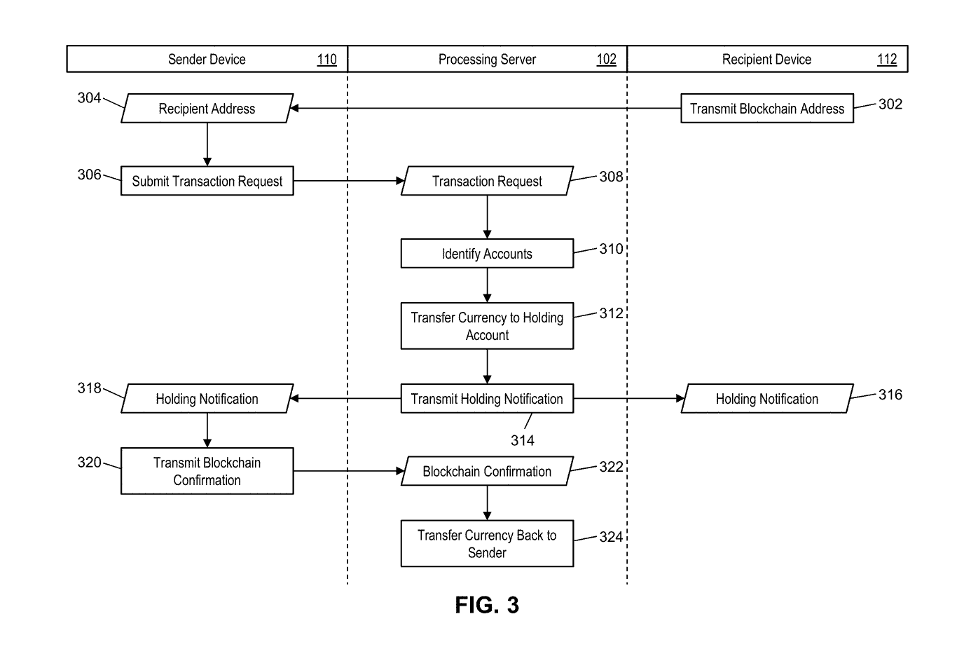

FIG. 3 illustrates an example process executed in the system 100 of FIG. 1 for the guaranteeing of a blockchain transaction via the use of an alternative currency and a shared transaction account between the sender 104 and the recipient 106.

In step 302, the recipient device 112 may transmit a blockchain address to be used as a recipient address in a blockchain transaction to the sender device 110. In step 304, the sender device 110 may receive the blockchain address. In some instances, the recipient device 112 may transmit the public key associated with the recipient's blockchain wallet to the sender device 110 where, in step 306, the sender device 110 may generate a recipient address using the public key. In step 306, the sender device 110 may electronically transmit a transaction request to the processing server 102 using a suitable communication network and method. The transaction request may include at least the recipient address, a blockchain currency amount to be transferred in a proposed blockchain transaction, and one or more sender addresses from which the blockchain currency is to be transferred to the recipient 106.

In step 308, the receiving device 202 of the processing server 102 may receive the transaction request. In some embodiments, the sender 104 may submit the proposed blockchain transaction to a node 114 in the blockchain network 108 before or after submission of the transaction request to the processing server 102. In other embodiments, the processing server 102 may submit (e.g., via the transmitting device 224 thereof) the proposed blockchain transaction to a node 114 based on the data included in the transaction request. In such embodiments, the transaction request may further include a digital signature generated by the sender device 110 and any other data that may be required by the node 114 to process the blockchain transaction.

In step 310, the querying module 218 of the processing server 102 may execute one or more queries on the account database 206 to identify an account profile 208 associated with the sender device 110 and an account profile 208 associated with the recipient device 112, which may be identified based on the sender and recipient addresses, respectively, in the transaction request. In some cases, the transaction request may include additional data that may be used for identification of the account profiles 208. The querying module 218 may also execute a query to associate the sender device 110 and recipient device 112 with a shared transaction account. In step 312, the transaction processing module 222 of the processing server 102 may process a transfer of an alternative currency amount from the sender's transaction account to the shared transaction holding account. The alternative currency amount may be based on the blockchain currency amount, and may be identified by the transaction processing module 222 based on an exchange rate for exchanging blockchain currency to the alternative currency (e.g., as stored in the memory 226 of the processing server 102).

In step 314, the transmitting device 224 of the processing server 102 may electronically transmit holding notifications to the sender device 110 and recipient device 112, notifying the respective users that the shared transaction account contains the proper alternative currency amount for holding awaiting processing of the proposed blockchain transaction. The recipient device 112 may receive the holding notification in step 316, which may be displayed to the recipient 106 as a user thereof. In step 318, the sender device 110 may receive the notification, which may be displayed to the sender 104 as a user thereof. In some embodiments, the sender 104 may wait to submit the blockchain transaction to the node 114 until the holding notification has been received.

In step 320, the sender device 110 may receive a confirmation that the blockchain transaction has been successfully processed and may electronically transmit the confirmation to the processing server 102. The confirmation may include data identifying the blockchain transaction that was included in a new block added to the blockchain, which may be used by the processing server 102 to ensure that the transfer of the specified amount of blockchain currency from the sending address(es) to the receiving address specified in the transaction request was executed successfully. In step 322, the receiving device 202 of the processing server 102 may receive the confirmation. In step 324, the transaction processing module 222 of the processing server 102 may process a transfer of the alternative currency amount from the shared transaction account back to the transaction account associated with the sender 104. In some embodiments, step 324 may not be performed until the sender 104 has specifically requested withdraw of the alternative currency from the shared transaction account.

### Exemplary Method for Guaranteeing a Blockchain Transaction via an Alternative Payment Network

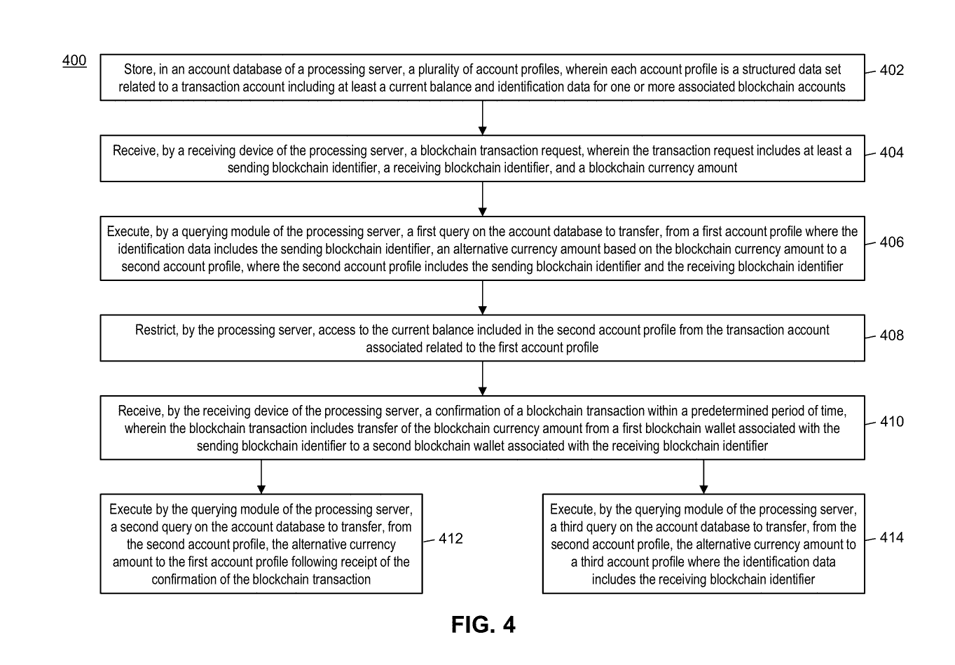

FIG. 4 illustrates a method 400 for the guaranteeing of a blockchain transaction with an alternative currency using a shared transaction account associated with both sender and recipient of the blockchain transaction, but which access thereto is restricted depending on the outcome of the blockchain transaction.

In step 402, a plurality of account profiles (e.g., account profiles 208) may be stored in an account database (e.g., the account database 206) of a processing server (e.g., the processing server 102), wherein each account profile is a structured data set related to a transaction account including at least a current balance and identification data for one or more associated blockchain accounts. In step 404, a blockchain transaction request may be received by a receiving device (e.g., the receiving device 202) of the processing server, wherein the transaction request includes at least a sending blockchain identifier, a receiving blockchain identifier, and a blockchain currency amount.

In step 406, a first query may be executed on the account database by a querying module (e.g., the querying module 218) of the processing server to transfer, from a first account profile where the identification data includes the sending blockchain identifier, an alternative currency amount based on the blockchain currency amount to a second account profile, where the second account profile includes the sending blockchain identifier and the receiving blockchain identifier. In step 408, access to the current balance included in the second account profile may be restricted by the processing server from the transaction account related to the first account profile.

In step 410, a confirmation of a blockchain transaction may be received by the receiving device of the processing server within a predetermined period of time, wherein the blockchain transaction includes transfer of the blockchain currency amount from a first blockchain wallet (e.g., the sender device 110) associated with the sending blockchain identifier to a second blockchain wallet (e.g., the recipient device 112) associated with the receiving blockchain identifier. If confirmation of the blockchain transaction is received within the predetermined period of time, then, in step 412, a second query may be executed on the account database by the querying module of the processing server to transfer, from the second account profile, the alternative currency amount to the first account profile following receipt of the confirmation of the blockchain transaction. If the confirmation is not received within a predetermined period of time, then, in step 414, a third query may be executed on the account database by the querying module 218 of the processing server 102 to transfer, from the second account profile, the alternative currency amount to a third account profile where the identification data includes the receiving blockchain identifier.

In one embodiment, the blockchain transaction request may be received from a first computing device (e.g., the sender device 110) configured to operate as the first blockchain wallet. In a further embodiment, the method 400 may also include receiving, by the receiving device of the processing server, a withdrawal request, wherein the withdrawal request includes at least the receiving blockchain identifier and the blockchain currency amount or the alternative currency amount. In an even further embodiment, the predetermined period of time may expire upon receipt of the withdrawal request. In another even further embodiment, the withdrawal request may further include the predetermined period of time. In yet another even further embodiment, the withdrawal request may be received from a second computing device (e.g., the recipient device 112) configured to operate as the second blockchain wallet.

In some embodiments, the method 400 may further include changing, by the processing server, the access restriction to the current balance from the transaction account associated with the first account profile to the transaction account associated with the third account profile after receiving the confirmation of the blockchain transaction. In one embodiment, the method 400 may also include receiving, by the receiving device of the processing server, a withdrawal request, wherein the withdrawal request includes at least the sending blockchain identifier, wherein the second query is not executed on the account database until receipt of the withdrawal request. In a further embodiment, the method 400 may even further include repeating, by the processing server, the receipt of the blockchain transaction request, execution of the first query, and receipt of the confirmation of the blockchain transaction for a second blockchain transaction for a second blockchain currency amount prior to receiving the withdrawal request, wherein execution of the second query includes transfer of the alternative currency amount and a second alternative currency amount based on the second blockchain currency amount. In another further embodiment, the withdrawal request may further include the sending blockchain identifier.

### Computer System Architecture

FIG. 5 illustrates a computer system 500 in which embodiments of the present disclosure, or portions thereof, may be implemented as computer-readable code. For example, the processing server 102 of FIG. 1 may be implemented in the computer system 500 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3 and 4.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 518, a removable storage unit 522, and a hard disk installed in hard disk drive 512.

Various embodiments of the present disclosure are described in terms of this example computer system 500. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 504 may be a special purpose or a general purpose processor device specifically configured to perform the functions discussed herein. The processor device 504 may be connected to a communications infrastructure 506, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 500 may also include a main memory 508 (e.g., random access memory, read-only memory, etc.), and may also include a secondary memory 510. The secondary memory 510 may include the hard disk drive 512 and a removable storage drive 514, such as a floppy disk drive, a magnetic tape drive, an optical disk drive, a flash memory, etc.

The removable storage drive 514 may read from and/or write to the removable storage unit 518 in a well-known manner. The removable storage unit 518 may include a removable storage media that may be read by and written to by the removable storage drive 514. For example, if the removable storage drive 514 is a floppy disk drive or universal serial bus port, the removable storage unit 518 may be a floppy disk or portable flash drive, respectively. In one embodiment, the removable storage unit 518 may be non-transitory computer readable recording media.

In some embodiments, the secondary memory 510 may include alternative means for allowing computer programs or other instructions to be loaded into the computer system 500, for example, the removable storage unit 522 and an interface 520. Examples of such means may include a program cartridge and cartridge interface (e.g., as found in video game systems), a removable memory chip (e.g., EEPROM, PROM, etc.) and associated socket, and other removable storage units 522 and interfaces 520 as will be apparent to persons having skill in the relevant art.

Data stored in the computer system 500 (e.g., in the main memory 508 and/or the secondary memory 510) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 500 may also include a communications interface 524. The communications interface 524 may be configured to allow software and data to be transferred between the computer system 500 and external devices. Exemplary communications interfaces 524 may include a modem, a network interface (e.g., an Ethernet card), a communications port, a PCMCIA slot and card, etc. Software and data transferred via the communications interface 524 may be in the form of signals, which may be electronic, electromagnetic, optical, or other signals as will be apparent to persons having skill in the relevant art. The signals may travel via a communications path 526, which may be configured to carry the signals and may be implemented using wire, cable, fiber optics, a phone line, a cellular phone link, a radio frequency link, etc.

The computer system 500 may further include a display interface 502. The display interface 502 may be configured to allow data to be transferred between the computer system 500 and external display 530. Exemplary display interfaces 502 may include high-definition multimedia interface (HDMI), digital visual interface (DVI), video graphics array (VGA), etc. The display 530 may be any suitable type of display for displaying data transmitted via the display interface 502 of the computer system 500, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 508 and secondary memory 510, which may be memory semiconductors (e.g., DRAMs, etc.). These computer program products may be means for providing software to the computer system 500. Computer programs (e.g., computer control logic) may be stored in the main memory 508 and/or the secondary memory 510. Computer programs may also be received via the communications interface 524. Such computer programs, when executed, may enable computer system 500 to implement the present methods as discussed herein. In particular, the computer programs, when executed, may enable processor device 504 to implement the methods illustrated by FIGS. 3 and 4, as discussed herein. Accordingly, such computer programs may represent controllers of the computer system 500. Where the present disclosure is implemented using software, the software may be stored in a computer program product and loaded into the computer system 500 using the removable storage drive 514, interface 520, and hard disk drive 512, or communications interface 524.

The processor device 504 may comprise one or more modules or engines configured to perform the functions of the computer system 500. Each of the modules or engines may be implemented using hardware and, in some instances, may also utilize software, such as corresponding to program code and/or programs stored in the main memory 508 or secondary memory 510. In such instances, program code may be compiled by the processor device 504 (e.g., by a compiling module or engine) prior to execution by the hardware of the computer system 500. For example, the program code may be source code written in a programming language that is translated into a lower level language, such as assembly language or machine code, for execution by the processor device 504 and/or any additional hardware components of the computer system 500. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 500 to perform the functions disclosed herein. It will be apparent to persons having skill in the relevant art that such processes result in the computer system 500 being a specially configured computer system 500 uniquely programmed to perform the functions discussed above.

Techniques consistent with the present disclosure provide, among other features, systems and methods for guaranteeing a blockchain transaction via an alternative payment network. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for guaranteeing a blockchain transaction via an alternative payment network, comprising:
storing, in an account database of a processing server, a plurality of account profiles, wherein each account profile is a structured data set related to a transaction account including at least a current balance and identification data for one or more associated blockchain accounts;
receiving, by a receiving device of the processing server, a blockchain transaction request, wherein the transaction request includes at least a sending blockchain identifier, a receiving blockchain identifier, and a blockchain currency amount;
executing, by a querying module of the processing server, a first query on the account database to transfer, from a first account profile where the identification data includes the sending blockchain identifier, an alternative currency amount based on the blockchain currency amount to a second account profile, where the second account profile includes the sending blockchain identifier and the receiving blockchain identifier;
restricting, by the processing server, access to the current balance included in the second account profile from the transaction account associated related to the first account profile;
receiving, by the receiving device of the processing server, a confirmation of a blockchain transaction within a predetermined period of time, wherein the blockchain transaction includes transfer of the blockchain currency amount from a first blockchain wallet associated with the sending blockchain identifier to a second blockchain wallet associated with the receiving blockchain identifier; and
executing, by the querying module of the processing server, a second query on the account database to transfer, from the second account profile, the alternative currency amount to the first account profile following receipt of the confirmation of the blockchain transaction if the confirmation is received within the predetermined period of time; or
executing, by the querying module of the processing server, a third query on the account database to transfer, from the second account profile, the alternative currency amount to a third account profile where the identification data includes the receiving blockchain identifier if the confirmation is not received within the predetermined period of time.

2. The method of claim 1, wherein the blockchain transaction request is received from a first computing device configured to operate as the first blockchain wallet.

3. The method of claim 2, further comprising:
receiving, by the receiving device of the processing server, a withdrawal request, wherein the withdrawal request includes at least the receiving blockchain identifier and the blockchain currency amount or the alternative currency amount.

4. The method of claim 3, wherein the predetermined period of time expires upon receipt of the withdrawal request.

5. The method of claim 3, wherein the withdrawal request further includes the predetermined period of time.

6. The method of claim 3, wherein the withdrawal request is received from a second computing device configured to operate as the second blockchain wallet.

7. The method of claim 1, further comprising:
changing, by the processing server, the access restriction to the current balance from the transaction account associated with the first account profile to the transaction account associated with the third account profile after receiving the confirmation of the blockchain transaction.

8. The method of claim 1, further comprising:
receiving, by the receiving device of the processing server, a withdrawal request, wherein the withdrawal request includes at least the sending blockchain identifier, wherein
the second query is not executed on the account database until receipt of the withdrawal request.

9. The method of claim 8, further comprising:
repeating, by the processing server, the receipt of the blockchain transaction request, execution of the first query, and receipt of the confirmation of the blockchain transaction for a second blockchain transaction for a second blockchain currency amount prior to receiving the withdrawal request, wherein
execution of the second query includes transfer of the alternative currency amount and a second alternative currency amount based on the second blockchain currency amount.

10. The method of claim 8, wherein the withdrawal request further includes the sending blockchain identifier.

11. A system for guaranteeing a blockchain transaction via an alternative payment network, comprising:
an account database of a processing server configured to store a plurality of account profiles, wherein each account profile is a structured data set related to a transaction account including at least a current balance and identification data for one or more associated blockchain accounts;
a receiving device of the processing server configured to receive a blockchain transaction request, wherein the transaction request includes at least a sending blockchain identifier, a receiving blockchain identifier, and a blockchain currency amount; and
a querying module of the processing server configured to execute a first query on the account database to transfer, from a first account profile where the identification data includes the sending blockchain identifier, an alternative currency amount based on the blockchain currency amount to a second account profile, where the second account profile includes the sending blockchain identifier and the receiving blockchain identifier, wherein
the processing server is configured to restrict access to the current balance included in the second account profile from the transaction account associated related to the first account profile,
the receiving device of the processing server is further configured to receive a confirmation of a blockchain transaction within a predetermined period of time, wherein the blockchain transaction includes transfer of the blockchain currency amount from a first blockchain wallet associated with the sending blockchain identifier to a second blockchain wallet associated with the receiving blockchain identifier, and
the querying module of the processing server is further configured to
execute a second query on the account database to transfer, from the second account profile, the alternative currency amount to the first account profile following receipt of the confirmation of the blockchain transaction if the confirmation is received within the predetermined period of time, or
execute a third query on the account database to transfer, from the second account profile, the alternative currency amount to a third account profile where the identification data includes the receiving blockchain identifier if the confirmation is not received within the predetermined period of time.

12. The system of claim 11, wherein the blockchain transaction request is received from a first computing device configured to operate as the first blockchain wallet.

13. The system of claim 12, wherein the receiving device of the processing server is further configured to receive a withdrawal request, wherein the withdrawal request includes at least the receiving blockchain identifier and the blockchain currency amount or the alternative currency amount.

14. The system of claim 13, wherein the predetermined period of time expires upon receipt of the withdrawal request.

15. The system of claim 13, wherein the withdrawal request further includes the predetermined period of time.

16. The system of claim 13, wherein the withdrawal request is received from a second computing device configured to operate as the second blockchain wallet.

17. The system of claim 11, wherein the processing server is further configured to change the access restriction to the current balance from the transaction account associated with the first account profile to the transaction account associated with the third account profile after receiving the confirmation of the blockchain transaction.

18. The system of claim 11, wherein
the receiving device of the processing server is further configured to receive a withdrawal request, wherein the withdrawal request includes at least the sending blockchain identifier, and
the second query is not executed on the account database until receipt of the withdrawal request.

19. The system of claim 18, wherein
the processing server is configured to repeat the receipt of the blockchain transaction request, execution of the first query, and receipt of the confirmation of the blockchain transaction for a second blockchain transaction for a second blockchain currency amount prior to receiving the withdrawal request, and
execution of the second query includes transfer of the alternative currency amount and a second alternative currency amount based on the second blockchain currency amount.

20. The system of claim 18, wherein the withdrawal request further includes the sending blockchain identifier.
